(19) United States
(12) Patent Application Publication
(10) Pub. No.: US 2023/0281571 A1
(43) Pub. Date: Sep. 7, 2023

(54) SERVER

(71) Applicant: TOYOTA JIDOSHA KABUSHIKI KAISHA, Toyota-shi (JP)

(72) Inventors: Toshiki KASHIWAKURA, Tokyo (JP); Kenichi YAMADA, Nisshin-shi (JP); Naoya OKA, Nagakute-shi (JP); Naoko MAEDA, Konan-shi (JP)

(21) Appl. No.: 18/151,724

(22) Filed: Jan. 9, 2023

(30) Foreign Application Priority Data
Mar. 2, 2022 (JP) 2022-032061

(51) Int. Cl. G06Q 10/20; G07C 5/00; G07C 5/08

(52) U.S. Cl. CPC G06Q 10/20; G07C 5/006; G07C 5/008; G07C 5/0858; G07C 5/0808

(57) ABSTRACT

A server that manages each of a plurality of vehicles includes a processor. The processor is configured to communicate with each of the vehicles, a first maintenance location, and a second maintenance location. Each of the vehicles includes a vehicle body and an on-board control device attached to the vehicle body. The first maintenance location is a location where maintenance of the vehicle body is able to be performed. The second maintenance location is a location where maintenance of the on-board control device is able to be performed. The processor is configured to acquire state information on a state of each of the vehicles. The processor is configured to decide assignment of maintenance of the vehicle to either or both of the first maintenance location and the second maintenance location, based on the state information.

### CROSS-REFERENCE TO RELATED APPLICATION

This application claims priority to Japanese Patent Application No. 2022-032061 filed on Mar. 2, 2022, incorporated herein by reference in its entirety.

### BACKGROUND

### 1. Technical Field

The present disclosure relates to servers.

### 2. Description of Related Art

For example, a service provision system described in Japanese Unexamined Patent Application Publication No. 2020-107074 (JP 2020-107074 A) delivers second key information different from first key information delivered to a user terminal to a service provider terminal when the service provision system receives a request for maintenance of a vehicle from a user. A service provider can drive the vehicle using his or her service provider terminal to which the second key information has been delivered. The service provider drives the vehicle to a maintenance facility, performs maintenance work. After the maintenance is completed, the service provider drives the vehicle back to its original parking location.

### SUMMARY

As described above, the service provision system described in JP 2020-107074 A delivers, to the service provider terminal, the second key information that allows the service provider to drive a vehicle when the service provision system receives a request for maintenance of the vehicle from a user. However, J P 2020-107074 A does not consider that there is a plurality of locations where vehicle maintenance is performed (first maintenance location and second maintenance location). When there is a plurality of locations where maintenance is performed, a user needs to select either the first maintenance location or the second maintenance location for maintenance, based on the state (abnormal state) of the vehicle. In this case, many users may select the same maintenance location, either the first maintenance location or the second maintenance location, due to some factor (e.g., the difference in name recognition between the first maintenance location and the second maintenance location). This may reduce the efficiency of maintenance at this maintenance location. Therefore, it is desired to reduce a decrease in efficiency of vehicle maintenance at the first maintenance location and the second maintenance location.

The present disclosure provides a server that can reduce a decrease in efficiency of vehicle maintenance at a first maintenance location and a second maintenance location.

A server configured to manage each of a plurality of vehicles according to a first aspect of the present disclosure includes a processor. The processor is configured to communicate with each of the vehicles, a first maintenance location, and a second maintenance location. Each of the vehicles includes a vehicle body and an on-board control device attached to the vehicle body. The on-board control device is configured to perform either or both of driving assistance control and autonomous driving control of the vehicle body. The first maintenance location is a location where maintenance of the vehicle body is able to be performed. The second maintenance location is a location where maintenance of the on-board control device is able to be performed. The processor is configured to acquire state information on a state of each of the vehicles. The processor is configured to decide assignment of maintenance of the vehicle to either or both of the first maintenance location and the second maintenance location, based on the state information.

In the server according to the above aspect, as described above, the processor decides assignment of maintenance of the vehicle to either or both of the first maintenance location and the second maintenance location, based on the state information of the vehicle. The maintenance destination is thus automatically decided by the processor. As a result, since the maintenance destination is not selected by users, the possibility can be reduced that selection of the maintenance destination may be concentrated on either the first maintenance location or the second maintenance location due to some factor (e.g., the difference in name recognition between the first maintenance location and the second maintenance location). This configuration can thus reduce a decrease in efficiency of vehicle maintenance at the first maintenance location and the second maintenance location.

In the server according to the first aspect of the present disclosure, the processor may be configured to acquire first schedule information of the first maintenance location and second schedule information of the second maintenance location. The processor may be configured to plan a schedule for the maintenance of the vehicle at either or both of the first maintenance location and the second maintenance location, based on the state information and either or both of the first schedule information and the second schedule information. With this configuration, since the schedule for maintenance is planned by the processor, the user does not need to plan a schedule for maintenance (decide maintenance time). This can save the user's time and effort.

In the server according to the first aspect of the present disclosure, the state information may include abnormality information of the vehicle. The processor may be configured to decide a length of time of the maintenance of the vehicle at either or both of the first maintenance location and the second maintenance location according to a type of an abnormality in the vehicle. The type of the abnormality may be based on the abnormality information. With this configuration, the length of time of the maintenance can be appropriately set for each kind of maintenance according to the type of abnormality. As a result, the maintenance can be more reliably completed within a scheduled time.

In the server according to the first aspect of the present disclosure, the processor may be configured to decide a time slot for the maintenance of the vehicle at either or both of the first maintenance location and the second maintenance location, based on the type of the abnormality and either or both of the first schedule information and the second schedule information. With this configuration, the user does not need to decide a time slot for maintenance. This can further save the user's time and effort.

In the server according to the first aspect of the present disclosure, the state information may include information indicating that a part of the vehicle needs to be replaced. The type of the abnormality may include a kind of the part that needs to be replaced. The processor may be configured to decide the length of time of the maintenance of the vehicle according to the kind of the part. The time required for maintenance varies depending on the kind of the part. For example, maintenance of an important part of the vehicle takes a relatively long time. Therefore, since the length of time of the maintenance is decided according to the kind of the part, the possibility that the time required for the maintenance may become longer than the scheduled maintenance time can be easily reduced.

In the server according to the first aspect of the present disclosure, the state information may include information indicating that a part of the vehicle needs to be replaced. The type of the abnormality may include a position where the part that needs to be replaced is located in the vehicle. The processor may be configured to decide the length of time of the maintenance of the vehicle according to the position. The time required for maintenance varies depending on the position of the part. For example, maintenance of a part located near an important part of the vehicle takes a relatively long time. Therefore, since the length of time of the maintenance is decided according to the position of the part, the possibility that the time required for the maintenance may become longer than the scheduled maintenance time can further be reduced.

In the server according to the first aspect of the present disclosure, the state information may include information on a state of the on-board control device. The first maintenance location may include a first dealership of the vehicle where control maintenance of the on-board control device is not able to be performed but replacement of a part of the on-board control device is able to be performed. The second maintenance location may include a first maintenance center where the control maintenance of the on-board control device and the replacement of a part of the on-board control device are able to be performed. The processor may be configured to plan a schedule for maintenance of the on-board control device at the first dealership and the first maintenance center, based on the state information including the information on the state of the on-board control device and either or both of the first schedule information and the second schedule information. Since the schedule for maintenance of the on-board control device is planned by the processor, the possibility that selection of the maintenance destination may be concentrated on the first dealership (or the first maintenance center) can be effectively reduced as compared to the case where users decide the maintenance destination.

In the server according to the first aspect of the present disclosure, the state information may include information indicating that a part of the on-board control device needs to be replaced. The first schedule information may include information indicating whether the part is able to be replaced with the part that is in stock at the first dealership. The processor may be configured to decide that the part is to be replaced at the first dealership when determination is made that the first dealership has enough stock of the part based on the first schedule information. The processor may be configured to decide that the part is to be replaced at the first maintenance center when determination is made that the first dealership does not have enough stock of the part based on the first schedule information. With this configuration, the possibility can be reduced that the first dealership not having enough stock of the part may be selected as a maintenance destination. Moreover, the possibility can be reduced that the first maintenance center may be selected as a maintenance destination even through the first dealership does not run short of stock of the part.

In the server according to the first aspect of the present disclosure, detachment of the on-board control device may also be able to be performed at the first dealership. The state information may include information indicating a control abnormality in the on-board control device. The first schedule information may include information on availability of the first dealership. The processor may be configured to decide that the on-board control device is to be detached from the vehicle at the first dealership and the control maintenance of the detached on-board control device is to be performed at the first maintenance center, when determination is made that the first dealership is not busy based on the first schedule information. The processor may be configured to decide that the control maintenance of the on-board control device is to be performed at the first maintenance center without detaching the on-board control device from the vehicle at the first dealership, when determination is made that the first dealership is busy based on the first schedule information. With this configuration, the possibility that the first dealership that is busy may be selected as a maintenance destination can be reduced. Moreover, the possibility that the first maintenance center may be selected as a maintenance destination even though the first dealership is not busy can also be reduced.

In the server according to the first aspect of the present disclosure, the state information may include the information on the state of the on-board control device and information on a state of the vehicle body. The first maintenance location may include a second dealership of the vehicle where the maintenance of the vehicle body is able to be performed. The second maintenance location may include a second maintenance center where the control maintenance of the on-board control device is able to be performed. The processor may be configured to decide that the maintenance of the vehicle body is to be performed at the second dealership when determination is made that the vehicle body is abnormal based on the state information. With this configuration, when the vehicle body is abnormal, the second dealership where the maintenance of the vehicle body can be performed can be selected as a maintenance destination.

In the server according to the first aspect of the present disclosure, the processor may be configured to decide that the maintenance of the vehicle is to be performed at the second dealership when determination is made that the on-board control device is abnormal and the vehicle body is abnormal but the vehicle is drivable based on the state information. With this configuration, the possibility can be reduced that the second maintenance center may be selected as a maintenance destination of the vehicle that is drivable although the on-board control device is abnormal and the vehicle body is abnormal.

In the server according to the first aspect of the present disclosure, the state information may include the information on the state of the on-board control device and the information on the state of the vehicle body. The processor may be configured to acquire the information on the state of the vehicle body directly from each of the vehicles. The processor may be configured to acquire the information on the state of the on-board control device of each of the vehicles via a management server configured to communicate with each of the vehicles. With this configuration, the processor can acquire the information on the state of the vehicle body and the information on the state of the on-board control device from separate communication partners (vehicle and management server). As a result, even when communication with one of the vehicle and the management server is lost, information (information on the state of the vehicle body or the state of the on-board control device) can be acquired from the other of the vehicle and the management server.

In the server according to the first aspect of the present disclosure, the state information may include a maintenance request signal that requests maintenance of an abnormal portion of the vehicle. The processor may be configured to acquire the maintenance request signal from each of the vehicles. With this configuration, assignment of the maintenance of the vehicle to either or both of the first maintenance location and the second maintenance location can be easily decided based on the acquired maintenance request signal.

With the present disclosure, it is possible to reduce a decrease in efficiency of vehicle maintenance at the first maintenance location and the second maintenance location.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows a Mobility as a Service (MaaS) system including an operation management center according to an embodiment;

FIG. 2 shows a schematic configuration of an autonomous driving kit (ADK);

FIG. 3 shows maintenances that can be performed by a dealer and an ADK maintenance center;

FIG. 4 shows the relationship between an abnormal state of a vehicle and maintenance time (time slot);

FIG. 5 shows the relationship between importance of parts of the vehicle (ADK) and maintenance time;

FIG. 6 shows the relationship between the distance between a Laser Imaging Detection and Ranging (LIDAR) and various parts and maintenance time;

FIG. 7 is a sequence diagram showing a control sequence of an operation management center etc.;

FIG. 8 is a flowchart showing the flow of step S10 and the subsequent steps (connector A in FIG. 7) of the operation management center; and

FIG. 9 is a flowchart showing the flow of step S20 and the subsequent steps (connector B in FIG. 7) of the operation management center.

### DETAILED DESCRIPTION OF EMBODIMENTS

Hereinafter, an embodiment of the present disclosure will be described in detail with reference to the drawings. The same or corresponding portions are denoted by the same signs throughout the drawings, and description thereof will not be repeated.

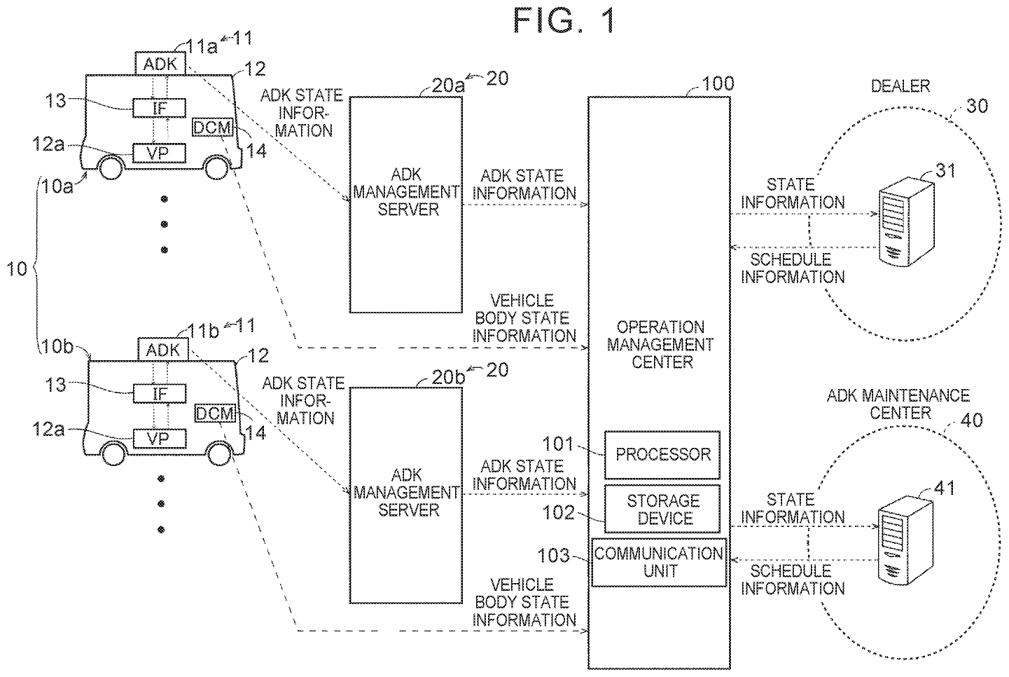

FIG. 1 shows an overview of a Mobility as a Service (MaaS) system that uses an operation management center 100 according to an embodiment of the present disclosure. The operation management center 100 is a server that manages a plurality of vehicles 10. The operation management center 100 is an example of the “server” in the present disclosure.

Referring to FIG. 1, the MaaS system includes vehicles 10, an autonomous driving kit (ADK) management server 20, an operation management center 100, a server 31 of a dealer 30, and a server 41 of an ADK maintenance center 40. The vehicles 10 are equipped with an ADK 11. The ADK management server 20 (20a, 20b that will be described later) is an example of the “management server” in the present disclosure. The dealer 30 is an example of the “first maintenance location,” “first dealership,” and “second dealership” in the present disclosure. The ADK maintenance center 40 is an example of the “second maintenance location,” “first maintenance center,” and “second maintenance center” in the present disclosure. The ADK 11 (11a, 11b that will be described later) is an example of the “on-board control device” in the present disclosure.

The vehicles 10 includes a plurality of vehicles 10a and a plurality of vehicles 10b. The ADK 11 includes an ADK 11a and an ADK 11b. The vehicle 10a (10b) includes an ADK 11a (11b), a vehicle body 12, a vehicle control interface 13, and a Data Communication Module (DCM) 14. The vehicle body 12 includes a vehicle platform (hereinafter referred to as “VP”) 12a. The vehicle 10a and the vehicle 10b may have different configurations from each other except for the ADK 11a (11b). The DCM 14 is an example of the “vehicle-side communication unit” in the present disclosure.

In the following description, the term “vehicle 10” is used when describing matters common to the vehicles 10a, 10b, and the term “ADK 11” is used when describing matters common to the ADKs 11a, 11b.

The ADK 11 performs driving assistance control and autonomous driving control of the vehicle body 12. The ADK 11 is attached to the vehicle body 12. Specifically, the ADK 11 is attached to the rooftop of the vehicle body 12, etc.

The vehicle control interface 13 can communicate with the ADK 11 through a Controller Area Network (CAN) etc. The vehicle control interface 13 receives various commands from the ADK 11 by running a predetermined application program interface (API) defined for each signal that is to be transferred. The vehicle control interface 13 also outputs the state of the vehicle body 12 to the ADK 11.

When the vehicle control interface 13 receives a command from the ADK 11, the vehicle control interface 13 outputs a control command corresponding to the command to the VP 12a. The vehicle control interface 13 also acquires various kinds of information on the vehicle body 12 from the VP 12a and outputs the state of the vehicle body 12 to the ADK 11.

The VP 12a includes various systems and sensors for controlling the vehicle body 12. The VP 12a performs various vehicle controls according to commands received from the ADK 11 via the vehicle control interface 13. That is, autonomous driving and driving assistance of the vehicle 10 are performed as the VP 12a performs various vehicle controls according to commands from the ADK 11.

The ADK 11 creates a travel plan for the vehicle 10. The ADK 11 outputs various control requests to cause the vehicle 10 to travel according to the travel plan to the VP 12a through the vehicle control interface 13 according to the API defined for each control request. The ADK 11 also receives various signals indicating the vehicle state (the state of the VP 12a) from the VP 12a through the vehicle control interface 13 according to the API defined for each signal. The ADK 11 reflects the vehicle state in the travel plan. The ADK 11 sends the travel plan, travel information, etc. to the ADK management server 20. The ADK 11 can also be detached from the vehicle body 12.

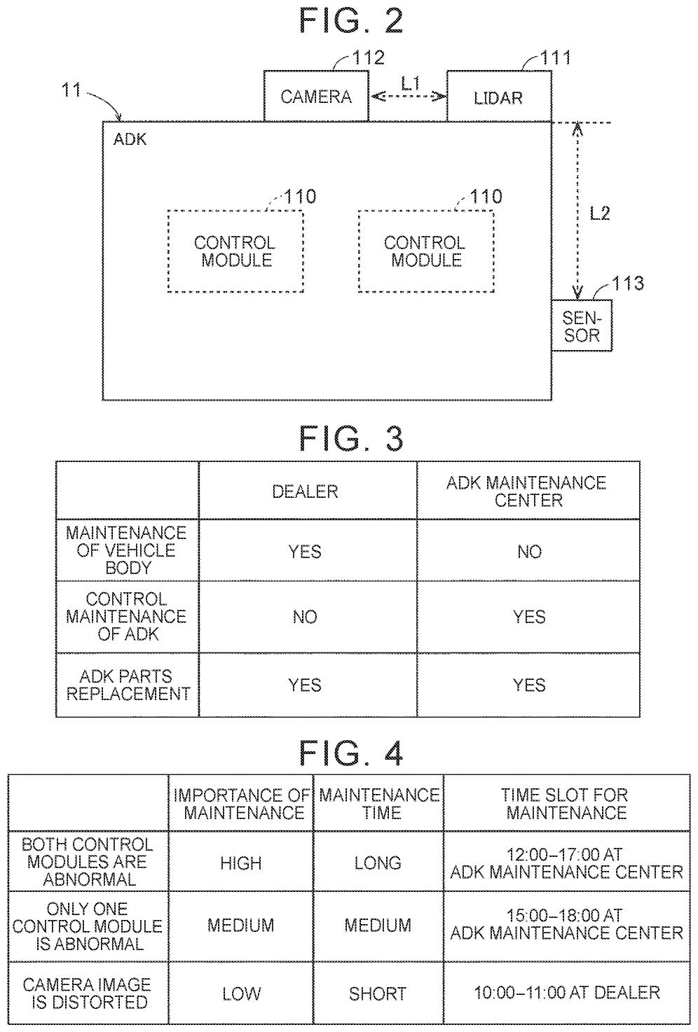

FIG. 2 is a schematic configuration of the ADK 11. As shown in FIG. 2, the ADK 11 includes two control modules 110, a Laser Imaging Detection and Ranging (LIDAR) 111, a camera 112, and a sensor 113. One of the two control modules 110 is a spare module. Each of the LIDAR 111, the camera 112, and the sensor 113 is an example of the “part” in the present disclosure.

The LIDAR 111 emits, for example, infrared pulsed laser light, and measures the distance to and direction of a target by detecting reflected light of the laser light from the target. A millimeter wave radar may be provided instead of (or in addition to) the LIDAR 111. The control module 110 controls travel of the vehicle 10 based on the distance and direction measured by the LIDAR 111.

The camera 112 is provided to capture an image outside the vehicle 10. The control module 110 grasps the location where the vehicle 10 is traveling based on the degree of matching between the image captured by the camera 112 and prestored images corresponding to each point, and controls travel of the vehicle 10.

The sensor 113 includes an attitude sensor etc. that detects the attitude, behavior, or location of the vehicle. The sensor 113 may include other types of sensors.

The VP 12a shown in FIG. 1 performs travel control in an autonomous driving mode according to a control request from the ADK 11. When the ADK 11 is detached, the VP 12a can also perform travel control in a manual mode (travel control according to driver's operations).

A user of the vehicle 10 is typically a private user. However, the present disclosure is not limited to this. The user may be a business operator that provides an autonomous driving service using the vehicle 10 (taxi service operator, rental car service provider, car sharing service provider, ride sharing service provider, etc.).

The ADK management server 20 is a server operated by a manufacturer of the ADK 11. The ADK management server 20 includes an ADK management server 20a and an ADK management server 20b. The ADK management server 20a and the ADK management server 20b are operated by different manufacturers.

The ADK management server 20a can communicate with the ADK 11a of each vehicle 10a. The ADK management server 20b can communicate with the ADK 11b of each vehicle 10b. In the following description, the term “ADK management server 20” is used when describing matters common to the ADK management servers 20a, 20b. The ADK management server 20 collects information on the state (abnormal state) of the ADK 11 from the ADK 11.

The operation management center 100 includes a processor 101, a storage device 102, and a communication unit 103. The processor 101 performs predetermined information processing. The storage device 102 is configured to save various kinds of information. The storage device 102 stores, in addition to programs to be executed by the processor 101, information to be used in the programs (e.g., maps, mathematical formulas, and various parameters). The communication unit 103 includes various communication interfaces (I/Fs). The processor 101 and the communication unit 103 are examples of the “server-side control unit” and the “server-side communication unit” in the present disclosure, respectively.

The communication unit 103 communicates with the DCM 14 of each vehicle 10 and each ADK management server 20 (20a, 20b). The communication unit 103 also communicates with the dealer 30 and the ADK maintenance center 40. Specifically, the communication unit 103 communicates with the server 31 that manages the dealer 30 and the server 41 that manages the ADK maintenance center 40.

The server 31 manages the schedule etc. of the dealer 30. The server 41 manages the schedule etc. of the ADK maintenance center 40. The communication unit 103 can acquire schedule information of the dealer 30 from the server 31. The communication unit 103 can also acquire schedule information of the ADK maintenance center 40 from the server 41. The schedule information of the dealer 30 and the schedule information of the ADK maintenance center 40 are examples of the “first schedule information” and the “second schedule information” in the present disclosure, respectively.

Only one dealer 30 and only one ADK maintenance center 40 are shown in FIG. 1 for simplicity. However, there may be a plurality of dealers 30 and a plurality of ADK maintenance centers 40. One server 31 (one server 41) may be provided for each dealer 30 (each ADK maintenance center 40), or one server 31 (one server 41) may be provided for the plurality of dealers 30 (plurality of ADK maintenance centers 40).

Each of the dealer 30 and the ADK maintenance center 40 performs maintenance on the vehicles 10. Specifically, as shown in FIG. 3, maintenance of the vehicle body 12 can be performed at the dealer 30. The parts of the ADK 11 can be replaced at the dealer 30. Control maintenance of the ADK 11 cannot be performed at the dealer 30. The ADK 11 can be detached at the dealer 30.

Maintenance of the ADK 11 can be performed at the ADK maintenance center 40. Specifically, control maintenance of the ADK 11 can be performed at the ADK maintenance center 40. The parts of the ADK 11 can be replaced at the ADK maintenance center 40. Maintenance of the vehicle body 12 cannot be performed at the ADK maintenance center 40.

The operation management center 100 is configured to manage information on each registered vehicle 10 (hereinafter also referred to as “vehicle information”), information on each registered user (hereinafter also referred to as “user information”), and information on each registered ADK (hereinafter also referred to as “ADK information”). The user information, the vehicle information, the ADK information are distinguished by identification information (ID) and stored in the storage device 102.

The operation management center 100 controls the communication unit 103 so that state information on the state of each vehicle 10 is acquired. Specifically, the communication unit 103 of the operation management center 100 acquires information on the state of the vehicle body 12 (VP 12a) directly from each vehicle 10 (DCM 14). Hereinafter, this information is also referred to as “vehicle body state information.” The operation management center 100 stores the vehicle body state information acquired from the vehicles 10 in the storage device 102. The communication unit 103 may indirectly acquire the vehicle body state information from each vehicle 10 via the ADK management server 20.

The communication unit 103 of the operation management center 100 also acquires information on the state of the ADK 11 of each vehicle 10 via the ADK management server 20 that communicates with each vehicle 10. Hereinafter, this information is also referred to as “ADK state information.” The operation management center 100 stores the ADK state information acquired from the vehicles 10 in the storage device 102. The communication unit 103 may acquire the ADK state information directly from each vehicle (ADK 11).

The state information (vehicle body state information and ADK state information) includes a maintenance request signal requesting maintenance of an abnormal portion of the vehicle 10 (ADK 11 and vehicle body 12). Therefore, the processor 101 controls the communication unit 103 so that a maintenance request signal is acquired from each vehicle 10.

The communication unit 103 of the operation management center 100 sends the acquired state information (vehicle body state information and ADK state information) to either or both of the server 31 of the dealer 30 and the server 41 of the ADK maintenance center 40. The communication unit 103 acquires the schedule information of the dealer 30 from the server 31 of the dealer 30 by sending the state information to the server 31. The communication unit 103 acquires the schedule information of the ADK maintenance center from the server 41 of the ADK maintenance center 40 by sending the state information to the server 41.

In related art, users need to select whether to have maintenance performed at the first maintenance location (dealer) or the second maintenance location (ADK maintenance center) (need to plan a schedule for maintenance). Therefore, many users may select the same maintenance location, either the first maintenance location or the second maintenance location, due to some factor (e.g., the difference in name recognition between the first maintenance location and the second maintenance location). This may reduce the efficiency of maintenance at this maintenance location. Therefore, it is desired to reduce a decrease in efficiency of vehicle maintenance at the first maintenance location and the second maintenance location.

In the present embodiment, the processor 101 decides assignment of maintenance of the vehicle 10 to either or both of the dealer 30 and the ADK maintenance center 40, based on the state information (maintenance request signal). Specifically, the processor 101 decides a maintenance destination (maintenance location) where maintenance for the state (abnormal state) of either or both of the ADK 11 and the vehicle body 12 detected based on the state information is to be performed.

For example, when the state information includes information indicating an abnormality in the vehicle body 12, maintenance is assigned to the dealer 30 that can perform maintenance of the vehicle body 12. When the state information includes information indicating a control abnormality in the ADK 11, maintenance is assigned to the ADK maintenance center 40 that can perform control maintenance of the ADK 11. When the state information includes both information indicating an abnormality in the vehicle body 12 and information indicating a control abnormality in the ADK 11, maintenance is assigned to both the dealer 30 and the ADK maintenance center 40.

The processor 101 plans a schedule for maintenance of the vehicle 10 at either or both of the dealer 30 and the ADK maintenance center 40, based on the state information and either or both of the schedule information of the dealer 30 and the schedule information of the ADK maintenance center 40. The processor 101 decides that maintenance is to be performed in a time slot available for maintenance at a maintenance destination that deals with an abnormality in the vehicle 10 detected based on the state information. The processor 101 may control the communication unit 103 so that maintenance is scheduled for this time slot at either or both of the dealer 30 and the ADK maintenance center 40.

The state information includes abnormality information of the vehicle 10. In this case, the processor 101 decides the length of time of maintenance of the vehicle 10 at either or both of the dealer 30 and the ADK maintenance center 40 according to the type of abnormality in the vehicle 10 that is based on the abnormality information.

For example, the processor 101 determines the importance of maintenance based on the details of the abnormality in the ADK 11. As shown in FIG. 4, the processor 101 determines that the importance of maintenance is high when both of the two control modules 110 (see FIG. 2) of the ADK 11 are abnormal. The processor 101 determines that the importance of maintenance is medium when one of the two control modules 110 of the ADK 11 is abnormal. When the image of the camera 112 (see FIG. 2) is distorted, the abnormality is very likely to be resolved by merely wiping the lens of the camera 112. Therefore, in this case, the processor 101 determines that the importance of maintenance is low. The above example of determining the importance is merely illustrative, and the present disclosure is not limited to this.

The importance of maintenance may be determined by the server 31 of the dealer 30 and the server 41 of the ADK maintenance center 40. In this case, the server 31 (server 41) sends information on the importance together with the schedule information to the operation management center 100.

The processor 101 then decides the length of time of maintenance based on the determined importance of maintenance. The processor 101 sets maintenance time to a large value (e.g., five hours), a medium value (e.g., three hours), and a small value (e.g., one hour) when the importance of maintenance is high, medium, and low, respectively. In the above example, the importance of maintenance (maintenance time) is divided into three levels. However, the present disclosure is not limited to this. The importance of maintenance (maintenance time) may be divided into two levels or four or more levels.

The processor 101 decides a time slot for maintenance of the vehicle 10 at either or both of the dealer 30 and the ADK maintenance center 40, based on the type of abnormality and either or both of the schedule information of the dealer 30 and the schedule information of the ADK maintenance center 40. Specifically, the processor 101 decides a time slot in which maintenance of the vehicle 10 is to be performed, based on the maintenance time decided based on the importance of maintenance and time slots available for maintenance (time slots available for appointments) at each of the dealer 30 and the ADK maintenance center 40.

For example, when the two control modules 110 are abnormal, the processor 101 decides that maintenance is to be performed in a time slot available for the long maintenance at the ADK maintenance center 40 where control maintenance of the ADK 11 can be performed (e.g., 12:00 to 17:00). When one of the control modules 110 is abnormal, the processor 101 decides that maintenance is to be performed in a time slot available for the medium-long maintenance at the ADK maintenance center 40 (e.g., 15:00 to 18:00).

When the image of the camera 112 is distorted, the processor 101 decides that maintenance is to be performed in a time slot available for the short maintenance at the dealer 30 or the ADK maintenance center 40 (e.g., 10:00 to 11:00 at the dealer 30).

When a plurality of time slots is available for maintenance, the processor 101 may select the earliest time slot, or may select a time slot based on the travel schedule of the vehicle 10. When maintenance can be performed at either the dealer 30 or the ADK maintenance center 40, the processor 101 may select the above time slot based on the availability of each of the dealer 30 and the ADK maintenance center 40.

The above examples of the maintenance time (time slot) are merely illustrative, and the present disclosure is not limited to these. For an abnormality in the vehicle body 12 as well, the maintenance time (time slot) may be similarly decided based on the type of abnormality (importance of maintenance).

It is herein assumed that the state information includes information indicating that a part of the vehicle 10 needs to be replaced. In this case, the type of abnormality includes the type of part that needs to be replaced.

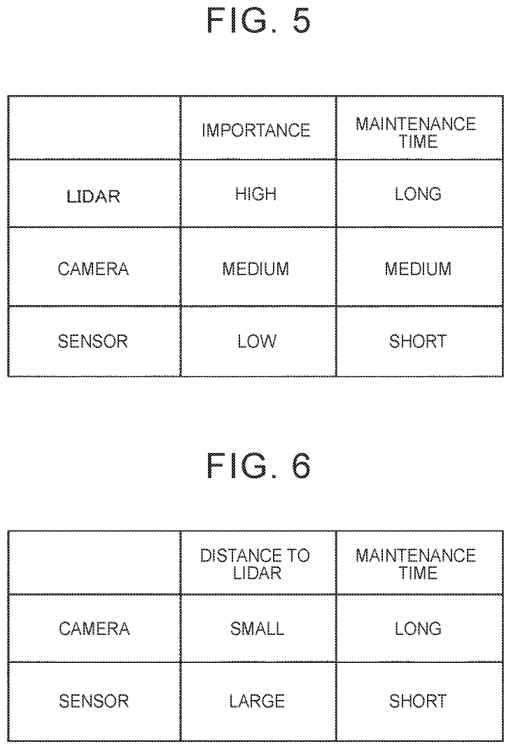

In the present embodiment, the processor 101 decides the length of time of maintenance of the vehicle 10 according to the type of part that needs to be replaced. Specifically, the importance is set to each part of the vehicle 10. For example, as shown in FIG. 5, the highest importance is set to the LIDAR 111, followed by the camera 112 and the sensor 113. The processor 101 may set the work time (maintenance time) to a larger value as the importance of the part that needs to be replaced is higher. An example in which a part of the ADK 11 needs to be replaced is described above. However, the maintenance time may be similarly decided when a part of the vehicle body 12 needs to be replaced.

The type of abnormality may include the position where the part that needs to be replaced is located in the vehicle 10. In this case, the processor 101 may decide the length of time of maintenance of the vehicle 10 according to this position. For example, as shown in FIG. 6, the processor 101 may set the maintenance time required to replace a part located at a relatively small distance to the LIDAR 111 to a relatively large value.

In the example shown in FIG. 2, the distance L1 between the camera 112 and the LIDAR 111 is smaller than the distance L2 between the sensor 113 and the LIDAR 111. Therefore, the replacement time (maintenance time) of the camera 112 may be set to a larger value than the replacement time (maintenance time) of the sensor 113. An example in which a part of the ADK 11 needs to be replaced is described above. However, similar control may be performed when a part of the vehicle body 12 needs to be replaced.

Different maintenance times may be set for parts of the same kind according to their distances to the LIDAR 111. The storage device 102 may store information on the distance between each part and the LIDAR 111. The distance to a portion other than the LIDAR 111 may be used as a reference.

The processor 101 decides a time slot for maintenance, based on the length of maintenance time decided for each part and the schedule information of each of the dealer and the ADK maintenance center 40.

The processor 101 may decide a time slot for maintenance by considering both the importance set in advance for each part and the distance to the LIDAR 111. The processor 101 may decide a time slot for maintenance by considering only either the importance set in advance for each part or the distance to the LIDAR 111.

### Sequence Control for Planning a Schedule

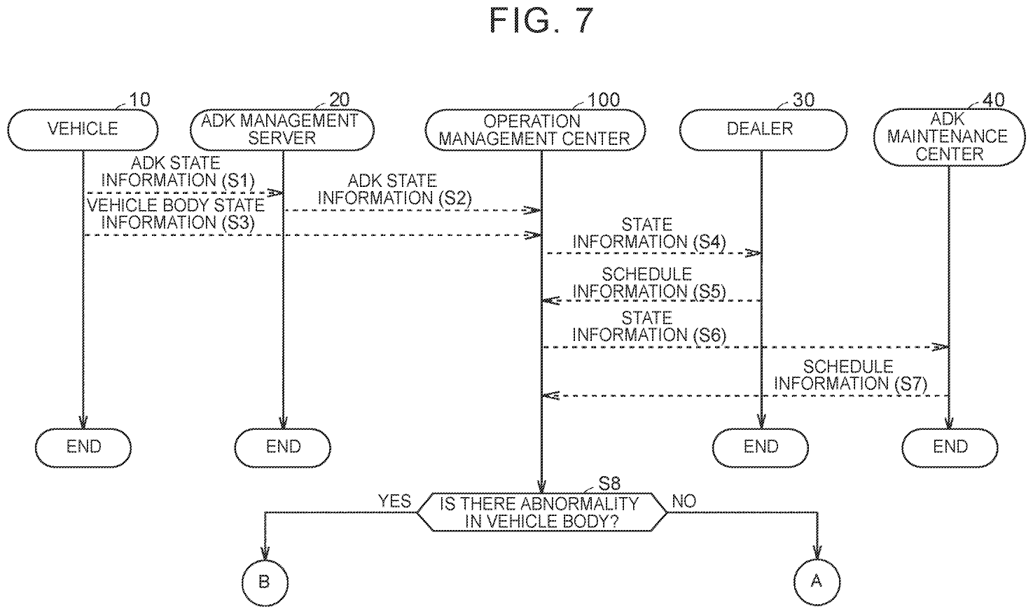

Next, sequence control for planning a schedule for maintenance by the operation management center 100 (processor 101) will be described with reference to FIGS. 7 to 9.

As shown in FIG. 7, the ADK 11 of the vehicle 10 first sends ADK state information to the ADK management server 20 in step S1. In step S2, the ADK management server 20 sends the ADK state information acquired in step S1 to the communication unit 103 of the operation management center 100. In step S3, the vehicle 10 sends vehicle body state information to the communication unit 103 of the operation management center 100 via the DCM 14 (see FIG. 1). Either step S1 or step S3 may be performed first, or steps S1, S3 may be performed at the same time.

Next, in step S4, the communication unit 103 of the operation management center 100 sends either or both of the ADK state information acquired in step S2 and the vehicle body state information acquired in step S3 to the dealer 30 (server 31). In step S5, the dealer 30 (server 31) sends schedule information of the dealer 30 to the communication unit 103 of the operation management center 100 in response to acquisition of the state information in step S4.

In step S6, the communication unit 103 of the operation management center 100 sends either or both of the ADK state information acquired in step S2 and the vehicle body state information acquired in step S3 to the ADK maintenance center 40 (server 41). In step S7, the ADK maintenance center 40 (server 41) sends schedule information of the ADK maintenance center 40 to the communication unit 103 of the operation management center 100 in response to acquisition of the state information in step S6. Either steps S4, S5 or steps S6, S7 may be performed first, or steps S4, S5 and steps S6, S7 may be performed at the same time.

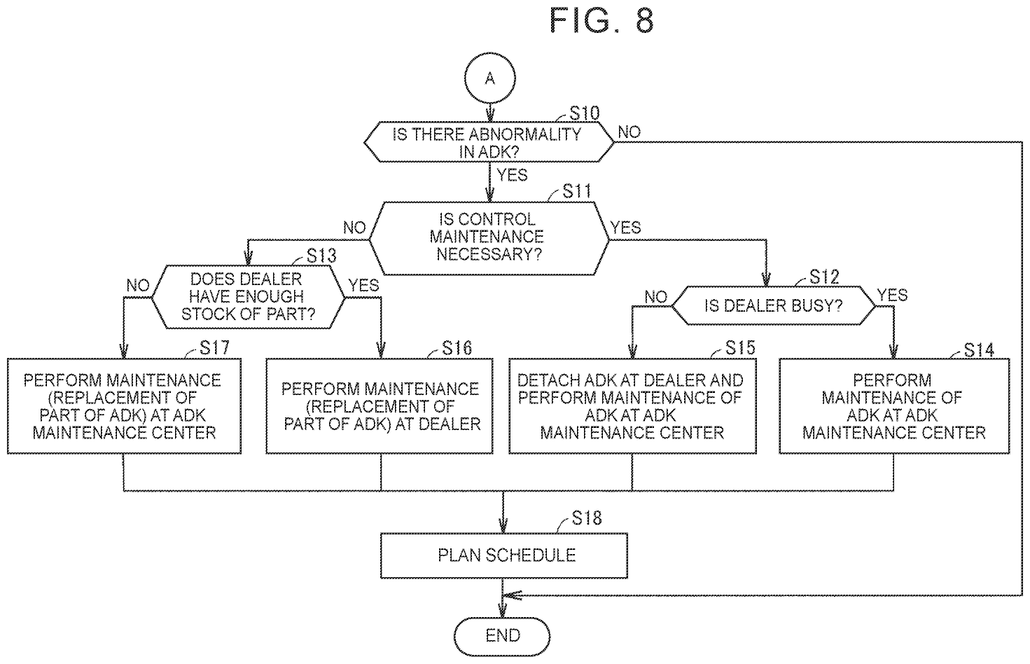

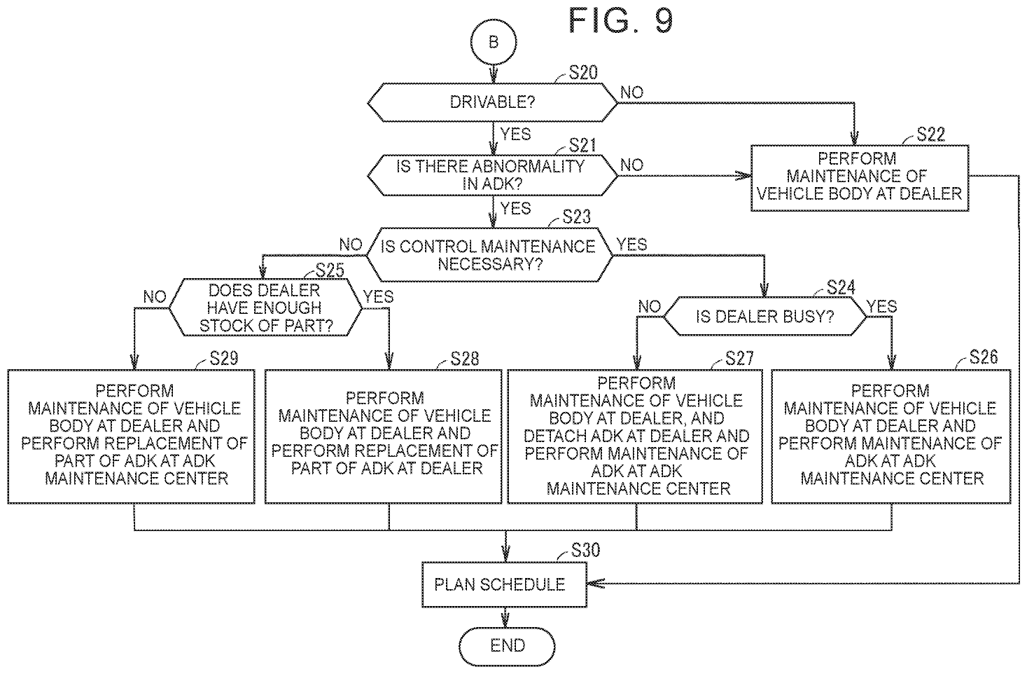

Thereafter, in step S8, the operation management center 100 (processor 101) determines whether there is an abnormality in the vehicle body 12, based on the state information (ADK state information and vehicle body state information) acquired in steps S2, S3. When it is determined that there is no abnormality in the vehicle body 12 because the state information does not include information indicating an abnormality in the vehicle body 12 (No in S8), the process proceeds to step S10 (see FIG. 8) (connector A). When it is determined that there is an abnormality in the vehicle body 12 because the state information includes information indicating an abnormality in the vehicle body 12 (Yes in S8), the process proceeds to step S20 (see FIG. 9) (connector B). In step S8, determination as to whether there is an abnormality in the ADK 11 (steps S10, S21 that will be described later) may be made before determination as to whether there is an abnormality in the vehicle body 12 is made.

As shown in FIG. 8, in step S10, the operation management center 100 (processor 101) determines whether there is an abnormality in the ADK 11. When it is determined that there is an abnormality in the ADK 11 because the state information includes information indicating an abnormality in the ADK 11 (Yes in S10), the process proceeds to step S11. When it is determined that there is no abnormality in the ADK 11 because the state information does not include information indicating an abnormality in the ADK 11 (No in S10), the process ends.

Thereafter, in step S11, the operation management center 100 (processor 101) determines whether control maintenance of the ADK 11 (e.g., maintenance of the control module(s) 110 (see FIG. 2)) is necessary. When it is determined that control maintenance of the ADK 11 is necessary because the state information includes information indicating a control abnormality in the ADK 11 (Yes in S11), the process proceeds to step S12. When it is determined that no control maintenance of the ADK 11 is necessary because the state information does not include information indicating a control abnormality in the ADK 11 (No in S11), the process proceeds to step S13. When the process proceeds to step S13, the state information includes information indicating that a part of the ADK 11 needs to be replaced.

The schedule information of the dealer 30 that is acquired in step S5 includes information on the availability of the dealer 30. In step S12, the operation management center 100 (processor 101) determines whether the dealer 30 is busy, based on the schedule information (information on availability) of the dealer 30. When it is determined that dealer is busy (Yes in S12), the process proceeds to step S14. When it is determined that the dealer 30 is not busy (No in S12), the process proceeds to step S15. The processor 101 may determine that the dealer 30 is busy when the dealer 30 is booked out for maintenance for a predetermined period (e.g., seven days from the time the determination is made).

In the case where there is a plurality of dealers 30 that can perform maintenance of the vehicle 10, the dealer 30 being busy means that all of the dealers 30 are busy and none of the dealers 30 are available for maintenance.

In step S14, the operation management center 100 (processor 101) decides that control maintenance of the ADK 11 is to be performed at the ADK maintenance center without detaching the ADK 11 from the vehicle 10 (vehicle body 12) at the dealer 30. That is, the processor 101 decides that the maintenance of the vehicle 10 with the ADK 11 attached to the vehicle body 12 is to be performed at the ADK maintenance center 40.

In step S15, the operation management center 100 (processor 101) decides that the ADK 11 is to be detached from the vehicle 10 (vehicle body 12) at the dealer 30 and control maintenance of the detached ADK 11 is to be performed at the ADK maintenance center 40. In this case, the ADK 11 detached at the dealer 30 may be mailed to the ADK maintenance center 40 by the dealer 30.

The schedule information of the dealer 30 acquired in step S5 includes information indicating whether the part of the ADK 11 can be replaced with a part that is in stock at the dealer 30. In step S13, the operation management center 100 (processor 101) determines whether the dealer 30 has enough stock of the part, based on the schedule information (stock status) of the dealer 30. When it is determined that the dealer 30 has enough stock of the part of the ADK 11 (Yes in S13), the process proceeds to step S16. When it is determined that the dealer 30 does not have enough stock of the part of the ADK 11 (No in S13), the process proceeds to step S17. The processor 101 may determine that the dealer does not have enough stock of the part when the number of parts that are in stock at the dealer 30 is a predetermined value (e.g., zero to four) or less.

In the case where there is a plurality of dealers 30 that can perform maintenance of the vehicle 10, the dealer 30 not having enough stock of the part means that none of the dealers 30 have enough stock of the part and therefore none of the dealers 30 are available for maintenance.

In step S16, the operation management center 100 (processor 101) decides that maintenance (replacement of the part of the ADK 11) is to be performed at the dealer 30.

In step S17, the operation management center 100 (processor 101) decides that maintenance (replacement of the part of the ADK 11) is to be performed at the ADK maintenance center 40. In this case, the processor 101 decides that the maintenance of the vehicle 10 with the ADK 11 attached to the vehicle body 12 is to be performed at the ADK maintenance center 40.

In step S18 after each of steps S14 to S17, the operation management center 100 (processor 101) plans a schedule for maintenance of the vehicle 10. Specifically, the processor 101 plans a schedule for maintenance of the vehicle 10, based on the state information, the schedule information of the dealer 30 acquired in step S5, and the schedule information of the ADK maintenance center 40 acquired in step S7. Since the method for planning a schedule is as described in detail above, description thereof will not be repeated.

In step S15, maintenance (detachment of the ADK 11 and control maintenance of the ADK 11) is performed at each of the dealer 30 and the ADK maintenance center 40. In this case, an appointment for maintenance may be scheduled at each of the dealer 30 and the ADK maintenance center 40. Specifically, the processor 101 may plan a schedule so that the ADK 11 will be detached from 10:00 to 11:00 at the dealer 30 and control maintenance of the ADK 11 will be performed from 12:00 to 17:00 at the ADK maintenance center 40.

As shown in FIG. 9, in step S20, the operation management center 100 (processor 101) determines whether the vehicle 10 is drivable. For example, the processor 101 determines whether the vehicle 10 is drivable, based on either or both of the ADK state information and the vehicle body state information. When it is determined that the vehicle is drivable (Yes in S20), the process proceeds to step S21. When it is determined that the vehicle 10 is not drivable (No in S20), the process proceeds to step S22. When it is determined that the vehicle 10 is not drivable (No in S20), the processor 101 may control the communication unit 103 to arrange for a tow truck etc. for transporting the vehicle 10.

Thereafter, in step S21, the operation management center 100 (processor 101) determines whether there is an abnormality in the ADK 11. When it is determined that there is an abnormality in the ADK 11 because the state information includes information indicating an abnormality in the ADK 11 (Yes in S21), the process proceeds to step S23. When it is determined that there is no abnormality in the ADK 11 because the state information does not include information indicating an abnormality in the ADK 11 (No in S21), the process proceeds to step S22.

In step S22, the operation management center 100 (processor 101) decides that maintenance of the vehicle body 12 is to be performed at the dealer 30. When it is determined in step S20 that the vehicle 10 is not drivable (No in S20), the processor 101 may decide that maintenance of the vehicle 10 is to be performed at an auto repair shop, not shown.

In step S23, the operation management center 100 (processor 101) determines whether control maintenance of the ADK 11 is necessary. When it is determined that control maintenance of the ADK 11 is necessary because the state information includes information indicating a control abnormality in the ADK 11 (Yes in S23), the process proceeds to step S24. When it is determined that no control maintenance of the ADK 11 is necessary because the state information does not include information indicating a control abnormality in the ADK 11 (No in S23), the process proceeds to step S25. When the process proceeds to step S25, the state information includes information indicating that a part of the ADK 11 needs to be replaced.

In step S24, the operation management center 100 (processor 101) determines whether the dealer 30 is busy, based on the schedule information of the dealer 30. When it is determined that dealer 30 is busy (Yes in S24), the process proceeds to step S26. When it is determined that the dealer 30 is not busy (No in S24), the process proceeds to step S27.

In step S26, the operation management center 100 (processor 101) decides that maintenance of the vehicle body 12 is to be performed at the dealer 30 and control maintenance of the ADK 11 is to be performed at the ADK maintenance center 40. Specifically, the processor 101 decides that control maintenance of the ADK 11 is to be performed at the ADK maintenance center 40 without detaching the ADK 11 from the vehicle 10 (vehicle body 12) at the dealer 30. In this case, the processor 101 may request the dealer 30 to prioritize maintenance of the vehicle body 12 over maintenance of other vehicles (e.g., relatively less urgent maintenance).

In step S27, the operation management center 100 (processor 101) decides that maintenance of the vehicle body 12 is to be performed at the dealer 30. The processor 101 also decides that the ADK 11 is to be detached from the vehicle 10 (vehicle body 12) at the dealer 30 and control maintenance of the detached ADK 11 is to be performed at the ADK maintenance center 40. In this case, the ADK 11 detached at the dealer 30 may be mailed to the ADK maintenance center 40 by the dealer 30.

In step S25, the operation management center 100 (processor 101) determines whether the dealer 30 has enough stock of the part of the ADK 11, based on the schedule information (stock status) of the dealer 30. When it is determined that the dealer 30 has enough stock of the part of the ADK 11 (Yes in S25), the process proceeds to step S28. When it is determined that the dealer 30 does not have enough stock of the part of the ADK 11 (No in S25), the process proceeds to step S29. The processor 101 may determine the stock status within a predetermined period (e.g., within three days from the time the determination is made).

In step S28, the operation management center 100 (processor 101) decides that maintenance of the vehicle body 12 and replacement of the part of the ADK 11 are to be performed at the dealer 30.

In step S29, the operation management center 100 (processor 101) decides that maintenance of the vehicle body 12 is to be performed at the dealer 30 and replacement of the part of the ADK 11 is to be performed at the ADK maintenance center 40. In this case, the processor 101 decides that the maintenance of the vehicle 10 with the ADK 11 attached to the vehicle body 12 is to be performed at the ADK maintenance center 40.

In step S30 after step S22 and after each of steps S26 to S29, the operation management center 100 (processor 101) plans a schedule for maintenance of the vehicle 10. Specifically, the processor 101 plans a schedule for maintenance of the vehicle 10, based on the state information, the schedule information of the dealer 30 acquired in step S5, and the schedule information of the ADK maintenance center 40 acquired in step S7. Since the method for planning a schedule is as described in detail above, description thereof will not be repeated.

As described above, in the present embodiment, the processor 101 decides assignment of maintenance of the vehicle 10 to either or both of the dealer 30 and the ADK maintenance center 40, based on the state information of the vehicle 10. The maintenance destination is thus decided by the processor 101. As a result, the user does not need to select a maintenance destination. This can save the user's time and effort. The maintenance destination is decided by the processor 101 based on the state of the vehicle 10. Therefore, appropriate maintenance according to the state of the vehicle 10 can be reliably performed at the maintenance destination. As a result, the state (abnormal state) of the vehicle 10 can be promptly improved.

In the present embodiment, the processor 101 plans a schedule for maintenance of the vehicle 10 at either or both of the dealer 30 and the ADK maintenance center 40, based on the state information, the schedule information of the dealer 30, and the schedule information of the ADK maintenance center 40.

The processor 101 can thus plan a schedule for maintenance of the vehicle 10, based on both the schedule information of the dealer 30 and the schedule information of the ADK maintenance center 40. As a result, for example, when the maintenance of the vehicle 10 can be performed at either the dealer 30 or the ADK maintenance center 40, it can be decided that maintenance is to be performed at either the dealer 30 or the ADK maintenance center 40, whichever maintenance destination where maintenance can be performed sooner. When the vehicle 10 requires maintenance at both the dealer 30 and the ADK maintenance center 40, the processor 101 can create an appropriate schedule based on the schedule of the dealer 30 and the schedule of the ADK maintenance center 40. For example, the time between the maintenance at the dealer 30 and the maintenance at the ADK maintenance center 40 can be adjusted to an appropriate length. Moreover, the possibility is reduced or eliminated that the time slot for the maintenance at the dealer 30 and the time slot for the maintenance at the ADK maintenance center 40 may overlap each other.

The above embodiment illustrates an example in which the processor 101 plans a schedule for maintenance based on either or both of the schedule information of the dealer 30 and the schedule information of the ADK maintenance center 40. However, the present disclosure is not limited to this. The processor 101 may decide assignment of maintenance to either or both of the dealer 30 and the ADK maintenance center 40 without using the schedule information (based only on the state information of the vehicle 10).

The above embodiment illustrates an example in which a schedule for maintenance is planned based on the availability and stock status of the dealer 30. However, the present disclosure is not limited to this. The processor 101 may plan a schedule for maintenance based on the availability and stock status of the ADK maintenance center 40.

The above embodiment illustrates an example in which the dealer 30 and the ADK maintenance center 40 are the maintenance destinations of the vehicle 10. However, the present disclosure is not limited to this. Maintenance may also be performed at places other than the dealer 30 and the ADK maintenance center 40 (e.g., an auto repair shop etc.).

The above embodiment illustrates an example in which the operation management center 100 (processor 101) plans maintenance based on both the schedule of the dealer 30 and the schedule of the ADK maintenance center 40. However, the present disclosure is not limited to this. The processor 101 may plan maintenance based on either the schedule of the dealer 30 or the schedule of the ADK maintenance center 40. For example, when the processor 101 determines that maintenance at either the dealer 30 or the ADK maintenance center 40 is not necessary based on the acquired state information, the processor 101 may not acquire the schedule information of either the dealer 30 or the ADK maintenance center 40, whichever the processor 101 determines that maintenance is not necessary.

The above embodiment illustrates an example in which the vehicle 10 is equipped with an ADK (on-board control device) that performs the driving assistance control and the autonomous driving control. However, the present disclosure is not limited to this. The vehicle 10 may be equipped with an on-board control device that performs either the driving assistance control or the autonomous driving control.

The configurations described in the above embodiment and the above various modifications may be combined as desired.

The embodiment disclosed herein should be considered to be illustrative and not restrictive in all respects. The scope of the present disclosure is shown by the claims rather than by the above description of the embodiment, and is intended to include all modifications within the meaning and scope equivalent to the claims.

What is claimed is:

1. A server configured to manage each of a plurality of vehicles, the server comprising a processor configured to:
communicate with each of the vehicles, a first maintenance location, and a second maintenance location, each of the vehicles including a vehicle body and an on-board control device attached to the vehicle body, the on-board control device being configured to perform either or both of driving assistance control and autonomous driving control of the vehicle body, the first maintenance location being a location where maintenance of the vehicle body is able to be performed, the second maintenance location being a location where maintenance of the on-board control device is able to be performed;
acquire state information on a state of each of the vehicles; and
decide assignment of maintenance of the vehicle to either or both of the first maintenance location and the second maintenance location, based on the state information.

2. The server according to claim 1, wherein the processor is configured to:
acquire first schedule information of the first maintenance location and second schedule information of the second maintenance location; and
plan a schedule for the maintenance of the vehicle at either or both of the first maintenance location and the second maintenance location, based on the state information and either or both of the first schedule information and the second schedule information.

3. The server according to claim 2, wherein:
the state information includes abnormality information of the vehicle; and
the processor is configured to decide a length of time of the maintenance of the vehicle at either or both of the first maintenance location and the second maintenance location according to a type of an abnormality in the vehicle, the type of the abnormality being based on the abnormality information.

4. The server according to claim 3, wherein the processor is configured to decide a time slot for the maintenance of the vehicle at either or both of the first maintenance location and the second maintenance location, based on the type of the abnormality and either or both of the first schedule information and the second schedule information.

5. The server according to claim 3, wherein
the state information includes information indicating that a part of the vehicle needs to be replaced,
the type of the abnormality includes a kind of the part that needs to be replaced, and
the processor is configured to decide the length of time of the maintenance of the vehicle according to the kind of the part.

6. The server according to claim 3, wherein:
the state information includes information indicating that a part of the vehicle needs to be replaced;
the type of the abnormality includes a position where the part that needs to be replaced is located in the vehicle; and
the processor is configured to decide the length of time of the maintenance of the vehicle according to the position.

7. The server according to claim 2, wherein:
the state information includes information on a state of the on-board control device;
the first maintenance location includes a first dealership of the vehicle where control maintenance of the on-board control device is not able to be performed but replacement of a part of the on-board control device is able to be performed;
the second maintenance location includes a first maintenance center where the control maintenance of the on-board control device and the replacement of a part of the on-board control device are able to be performed; and
the processor is configured to plan a schedule for maintenance of the on-board control device at the first dealership and the first maintenance center, based on the state information including the information on the state of the on-board control device and either or both of the first schedule information and the second schedule information.

8. The server according to claim 7, wherein:
the state information includes information indicating that a part of the on-board control device needs to be replaced;
the first schedule information includes information indicating whether the part is able to be replaced with the part that is in stock at the first dealership; and
the processor is configured to
decide that the part is to be replaced at the first dealership when determination is made that the first dealership has enough stock of the part based on the first schedule information, and
decide that the part is to be replaced at the first maintenance center when determination is made that the first dealership does not have enough stock of the part based on the first schedule information.

9. The server according to claim 7, wherein:
detachment of the on-board control device is also able to be performed at the first dealership;
the state information includes information indicating a control abnormality in the on-board control device;
the first schedule information includes information on availability of the first dealership; and
the processor is configured to
decide that the on-board control device is to be detached from the vehicle at the first dealership and the control maintenance of the detached on-board control device is to be performed at the first maintenance center, when determination is made that the first dealership is not busy based on the first schedule information, and
decide that the control maintenance of the on-board control device is to be performed at the first maintenance center without detaching the on-board control device from the vehicle at the first dealership, when determination is made that the first dealership is busy based on the first schedule information.

10. The server according to claim 1, wherein:
the state information includes the information on the state of the on-board control device and information on a state of the vehicle body;
the first maintenance location includes a second dealership of the vehicle where the maintenance of the vehicle body is able to be performed;
the second maintenance location includes a second maintenance center where the control maintenance of the on-board control device is able to be performed; and
the processor is configured to decide that the maintenance of the vehicle body is to be performed at the second dealership when determination is made that the vehicle body is abnormal based on the state information.

11. The server according to claim 10, wherein the processor is configured to decide that the maintenance of the vehicle is to be performed at the second dealership when determination is made that the on-board control device is abnormal and the vehicle body is abnormal but the vehicle is drivable based on the state information.

12. The server according to claim 1, wherein:
the state information includes the information on the state of the on-board control device and the information on the state of the vehicle body; and
the processor is configured to
acquire the information on the state of the vehicle body directly from each of the vehicles, and
acquire the information on the state of the on-board control device of each of the vehicles via a management server configured to communicate with each of the vehicles.

13. The server according to claim 1, wherein
the state information includes a maintenance request signal that requests maintenance of an abnormal portion of the vehicle, and
the processor is configured to acquire the maintenance request signal from each of the vehicles.
